(19) United States
(12) Patent Application Publication
(10) Pub. No.: US 2007/0285842 A1
(43) Pub. Date: Dec. 13, 2007

(54) Method and apparatus for a base plate used in a head gimbal assembly of a hard disk drive

(76) Inventors: Momo Boljanovic, Milpitas, CA (US); Joseph Chang, San Jose, CA (US); Shiao-Hua Chen, Palo Alto, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/450,156

(22) Filed: Jun. 8, 2006

(51) Int. Cl. G11B 5/48

(52) U.S. Cl. 360/245.3

(57) ABSTRACT

The invention includes a flexure finger for coupling to a load beam in a head suspension assembly of a hard disk drive. The flexure finger reduces buckling in the tail transition region near the head gimbal assembly by including at least two stress relief gaps in a stainless steel layer in the tail transition region near the head gimbal assembly.

### TECHNICAL FIELD

This invention relates to hard disk drive components, in particular, to a flexure finger near the head gimbal assembly in the actuator assembly in the hard disk drive.

### BACKGROUND OF THE INVENTION

Contemporary hard disk drives include an actuator assembly pivoting through an actuator pivot to position one or more read-write heads, embedded in sliders, each over a rotating disk surface. The data stored on the rotating disk surface is typically arranged in concentric tracks. To access the data of a track, a servo controller first positions the read-write head by electrically stimulating the voice coil motor, which couples through the voice coil and an actuator arm to move a head gimbal assembly in positioning the slider close to the track.

The head gimbal assembly includes a flexure finger which couples to the read-write head in the slider and sometimes, to a micro-actuator assembly. The micro-actuator assembly is used for fine positioning of the read-write head through its coupling to the slider.

Often, the flexure finger contains a layer of stainless steel, which adds strength to the flexure finger, which typically also includes a layer of polymide and at least one layer of conductive traces, which are often made of copper. Gaps are sometimes formed in the stainless steel layer to provide impedance matching for the conductive traces.

While this technology is good, it is not perfect, and there are continuing problems with the quality of actuator assemblies in hard disk drives. There is a continuing need to improve the quality of the actuator assembly and its components in a hard disk drive.

### SUMMARY OF THE INVENTION

The inventors discovered a quality problem in actuator assemblies in hard disk drives. The flexure fingers were experiencing buckling in the tail transition region near the head gimbal assembly.

The invention includes a flexure finger for coupling to a load beam in a head suspension assembly of a hard disk drive. The flexure finger solves the problem the inventors encountered by including at least two stress relief gaps in a stainless steel layer in the tail transition region near the head gimbal assembly. The flexure finger may include a succession of impedance matching gaps opposite the stress relief gaps in the stainless steel layer in the tail transition region. The flexure finger may include more than two stress relief gaps in the stainless steel layer. Additionally, the flexure finger may include a micro-actuator assembly coupling to the stainless steel layer. The flexure finger may be included in a flex circuit including a main flex circuit, which may house a preamplifier and may further provide a ribbon cable site for electrical communication with an embedded printed circuit board. The invention includes manufacturing the flexure finger by making the stress relief gaps in the stainless steel layer. The flexure finger is a product of this process.

The invention includes a head suspension assembly. The head suspension assembly includes the flexure finger coupled to a load beam. The invention includes manufacturing the head suspension assembly by coupling the flexure finger to the load beam. The head suspension assembly is a product of this manufacturing process.

The invention includes a head gimbal assembly. The head gimbal assembly includes the head suspension assembly with the flexure finger coupling to a slider. The invention also includes a method of making the head gimbal assembly by coupling the flexure finger to the slider. Coupling the slider to the flexure finger may further include coupling the slider to a micro-actuator assembly mounted on the flexure finger. The head gimbal assembly is a product of the manufacturing process.

The invention includes an actuator assembly. The actuator assembly includes at least one of the head gimbal assemblies coupling to at least one actuator arm. The invention includes a method of manufacturing the actuator assembly, including coupling at least one of the head gimbal assemblies to at least one actuator arm. The actuator assembly is a product of this process.

The invention includes a hard disk drive. The hard disk drive includes the actuator assembly pivotably mounted by an actuator pivot to a disk base. The method of manufacturing includes pivotably mounting the actuator assembly to the disk base to create the hard disk drive, which is a product of this process.

### BRIEF DESCRIPTION OF THE DRAWINGS

FIG. 1A shows a prior art stainless steel layer of a flexure finger;

FIG. 1B shows a stainless steel layer of the invention;

FIG. 1C shows the stainless steel layer of FIG. 1B in relation to the components of a head suspension assembly;

FIG. 1D shows the location of the quality problem found by the inventors in actuator assemblies using the prior art stainless steel layer shown in FIG. 1A;

FIG. 2A shows a top view of the head suspension assembly of FIG. 1C;

FIG. 2B shows a side view of a head gimbal assembly using the head suspension assembly of FIGS. 1C and 2A;

FIG. 3 shows a main flex circuit for coupling to the flexure finger of FIG. 1B;

FIG. 4 shows the preamplifier coupling to the main flex circuit of FIG. 3;

FIG. 5 shows the components of the head suspension assembly and the head gimbal assembly including the head suspension assembly;

FIG. 6 shows the head gimbal assemblies coupling to the actuator arms of an actuator assembly; and

FIGS. 7 and 8 show various elements of the invention included in a hard disk drive.

### DETAILED DESCRIPTION

This invention relates to hard disk drive components, in particular, to a flexure finger near the head gimbal assembly in the actuator assembly in the hard disk drive.

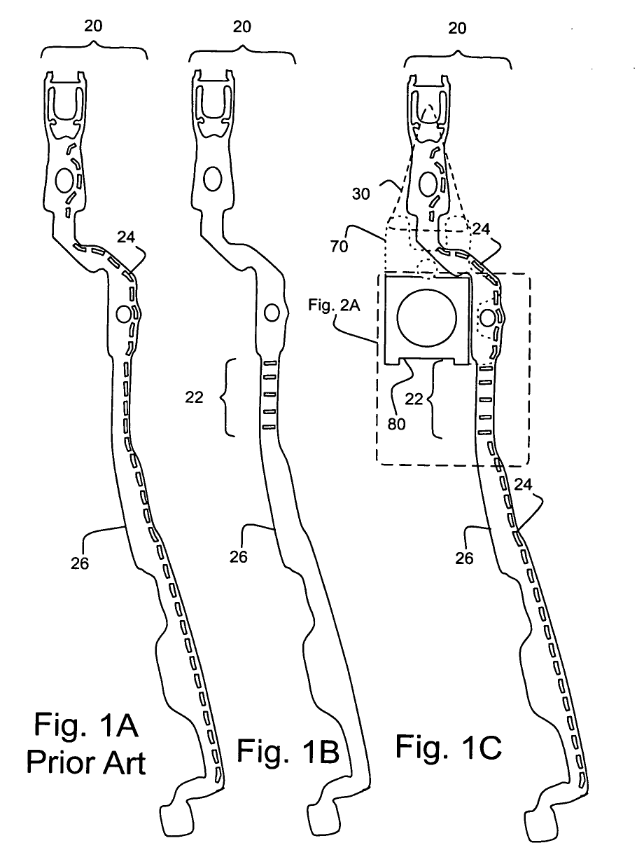

The inventors discovered a quality problem in actuator assemblies in hard disk drives, as shown in FIG. 1D. Buckling was observed in the tail transition region 64 near the head gimbal assembly 60, for at least the second flexure finger 20-2 and the third flexure finger 20-3.

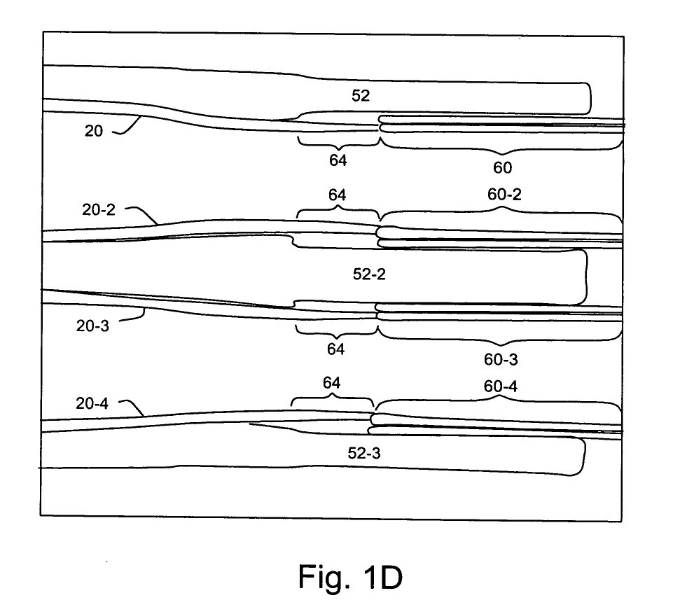

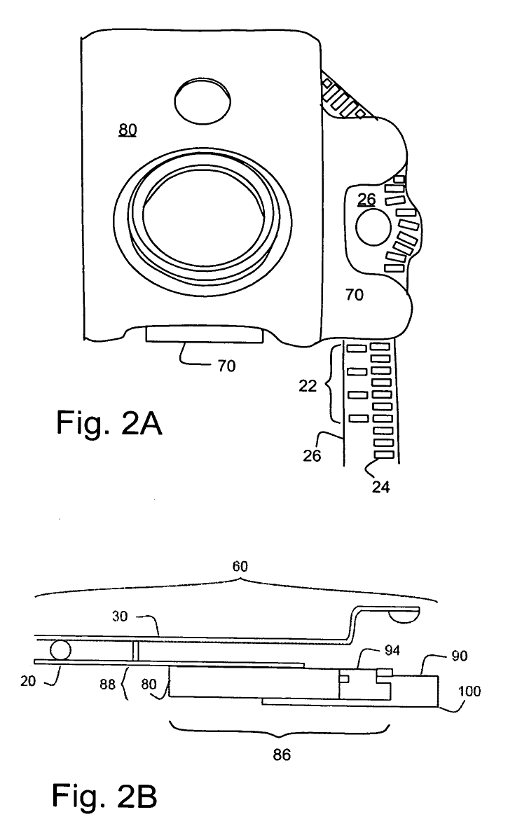

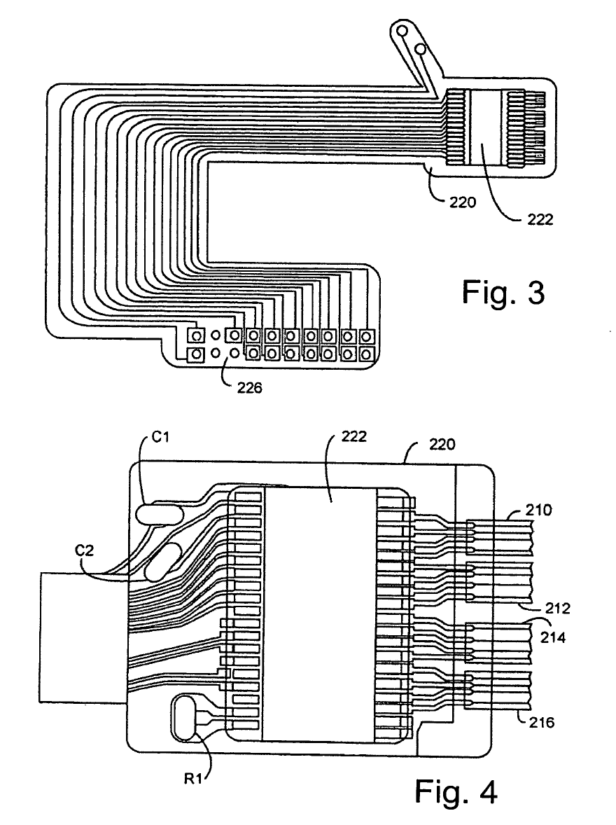

The invention includes a flexure finger 20 for coupling to a load beam 30 in a head suspension assembly 62 of a hard disk drive 10, as shown in FIGS. 1B, 1C, 2A, 2D, and 5. The flexure finger solves the problem the inventors encountered by including at least two stress relief gaps 22 in a stainless steel layer 26 in the tail transition region 64 near the head gimbal assembly 60. The flexure finger may include a succession of impedance matching gaps 24 opposite the stress relief gaps in the stainless steel layer in the tail transition region. The flexure finger may include more than two stress relief gaps in the stainless steel layer. Additionally, the flexure finger may include a micro-actuator assembly 86 coupling to the stainless steel layer, as shown in FIG. 2B. The flexure finger may be included in a flex circuit including a main flex circuit 220 as shown in FIG. 3, which may house a preamplifier 222 and may further provide a ribbon cable site 226 for electrical communication with an embedded printed circuit board, as shown in FIG. 4. The ribbon cable site may preferably be used for electrical communication with an embedded printed circuit board, which is not shown.

The invention includes manufacturing the flexure finger 20 by making the stress relief gaps 22 in the stainless steel layer 26. The flexure finger is a product of this process.

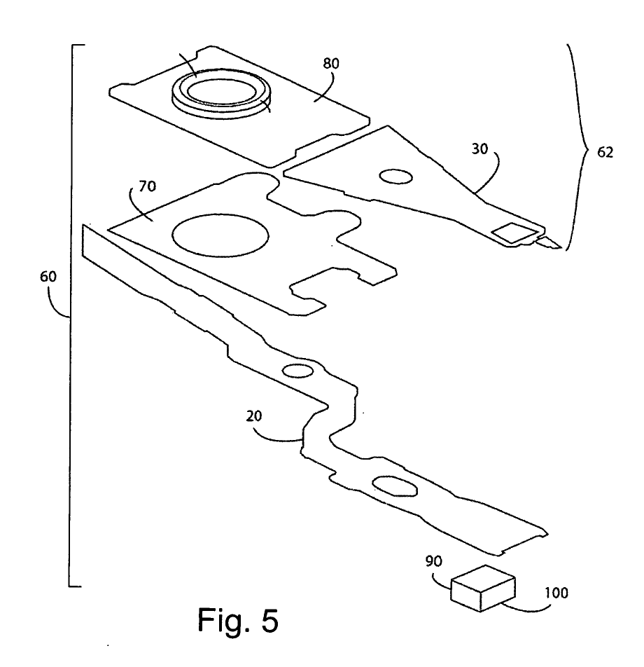

The invention includes a head suspension assembly 62, as shown in FIG. 5. The head suspension assembly includes the flexure finger 20 coupled to a load beam 30 as shown in FIG. 2A. The invention includes manufacturing the head suspension assembly by coupling the flexure finger to the load beam. The head suspension assembly is a product of this manufacturing process.

The head suspension assembly 62 of FIG. 5 includes the load beam 30, a hinge 70 and the base plate 80. The making of the head suspension assembly includes attaching the load beam to the hinge. The hinge is attached to the base plate.

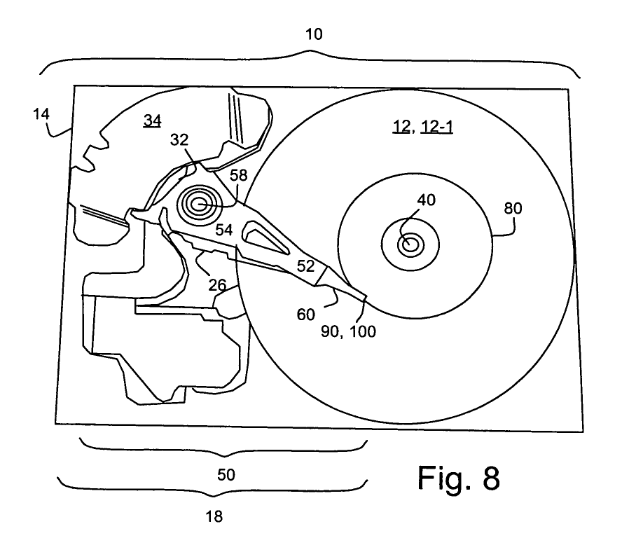

The invention includes a head gimbal assembly 60. The head gimbal assembly includes the head suspension assembly 62 with the flexure finger 20 coupling to a slider 90 as shown in FIG. 2B. A head gimbal assembly 60 further includes the head suspension assembly 62, a slider 90, connected electrically and mechanically to a flexure finger 20. The flexure finger is attached to at least the load beam 30. The slider includes the read-write head 100 as shown in FIG. 2B, which is embedded in it, forming an air-bearing surface for flying a few nano-meters off the disk surface 12-1 during normal access operations of the hard disk drive 10 as shown in FIG. 8.

The invention also includes a method of making the head gimbal assembly by coupling the flexure finger to the slider. Coupling the slider to the flexure finger may further include coupling the slider to a micro-actuator assembly 86 mounted on the flexure finger as shown in FIG. 2B. The head gimbal assembly is a product of the manufacturing process.

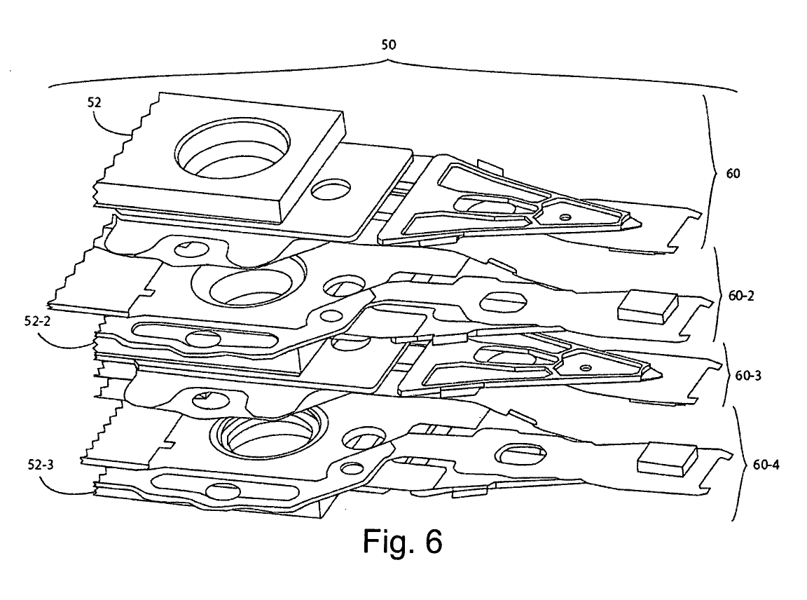

The invention includes an actuator assembly 50, as shown in FIGS. 6 to 8. The actuator assembly includes at least one head gimbal assembly 60 coupling to at least one actuator arm 52. The invention includes a method of manufacturing the actuator assembly, including coupling at least one of the head gimbal assemblies to at least one actuator arm. The actuator assembly is a product of this process. The coupling may further include at least one of: coupling one of the head gimbal assemblies to at least one of the actuator arms, and coupling two of the head gimbal assemblies to at least one of the actuator arms.

By way of example, an actuator assembly for a hard disk drive including two disks as shown in FIG. 6 may preferably be made by coupling one head gimbal assembly to each of two actuator arms 52 and 52-3, and coupling two of the head gimbal assemblies to one actuator arm 52-2.

The base plate 80 of the head gimbal assembly provides the top layer coupling the actuator arm 52 to the head gimbal assembly.

The invention includes a hard disk drive 10. The hard disk drive includes the actuator assembly 50 pivotably mounted by an actuator pivot 116 to a disk base 14. The method of manufacturing includes pivotably mounting the actuator assembly to the disk base to create the hard disk drive, which is a product of this process.

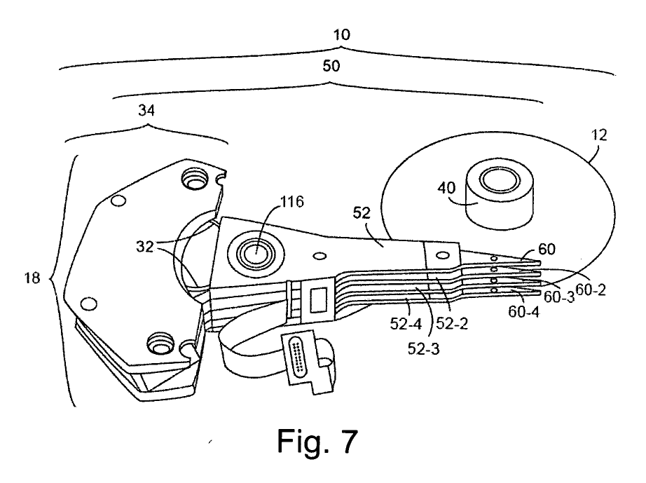

FIGS. 7 and 8 show a partially assembled hard disk drive 10 including the head gimbal assembly 60 coupled with an actuator arm 52, included in a voice coil motor 18. The voice coil motor includes an actuator assembly 50, which includes the head gimbal assembly 60.

A disk surface 12-1 is shown rotating about spindle 40 to create the rotating disk surface. The actuator assembly 50 pivots about the actuator pivot 116. The actuator assembly includes the actuator arm 52 coupled with the voice coil 32. When the voice coil is electrically stimulated with a time-varying electrical signal, it inductively interacts with a fixed magnet 34 attached to the voice coil yoke, causing the actuator arm to pivot by lever action through the actuator pivot. Typically, the fixed magnet is composed of two parts, one attached to the voice coil yoke and the other attached to the bottom voice coil yoke. As the actuator arm pivots, the head gimbal assembly 60 is moved across the disk surface 12-1. This provides the coarse positioning of the slider 90, and consequently, the read-write head 100 over a specific track.

The hard disk drive may further include a second rotating disk surface, to which the second actuator arm 52-2 may position the second head gimbal assembly 60-2. An embedded printed circuit board is used to control the positioning of the read-write head 100, possibly by also using a micro-actuator assembly 86, as well as the coarse positioning through the interactions with the voice coil 32, the fixed magnet 34 and the actuator arm 52 of the actuator assembly 50.

The preceding embodiments provide examples of the invention and are not meant to constrain the scope of the following claims.

What is claimed is:

1. A flexure finger for coupling to a load beam in a head suspension assembly of a hard disk drive, comprising: at least two tail stress relief gaps in a stainless steel layer in the tail transition region near said head suspension assembly.

2. The flexure finger of claim 1, further comprising: a succession of impedance matching gaps in said stainless steel layer in said tail transition region and opposite said tail stress relief gaps.

3. The flexure finger of claim 1, further comprising: at least three of said tail stress relief gaps in said stainless steel layer in said tail transition region near said head suspension assembly.

4. The flexure finger of claim 1, further comprising: a micro-actuator assembly coupling to said stainless steel layer.

5. The head suspension assembly, comprising: said flexure finger of claim 1 coupled to said load beam.

6. A head gimbal assembly, comprising: said head suspension assembly of claim 5 coupling to a slider, further comprising: said flexure finger coupling to said slider.

7. An actuator assembly, comprising: at least one of said head gimbal assemblies of claim 6 coupling to at least one actuator arm.

8. The hard disk drive, comprising: said actuator assembly of claim 7 pivotably mounted via an actuator pivot to a disk base.

9. A method of manufacturing said hard disk drive, comprising the step: pivotably mounting said actuator assembly by said actuator pivot to said disk base to create said hard disk drive.

10. The hard disk drive as a product of the process of claim 9.

11. A method of manufacturing said actuator assembly of claim 7, comprising the steps:
coupling at least one of said head gimbal assemblies to at least one of said actuator arms to create said actuator assembly.

12. The method of claim 11, wherein the step coupling at least one of said head gimbal assemblies, further comprises one of the steps:
coupling one of said head gimbal assemblies to at least one of said actuator arms; and
coupling two of said head gimbal assemblies to at least one of said actuator arms.

13. The actuator assembly as a product of the process of claim 11.

14. A method of making said head gimbal assembly of claim 6, comprising the step:
coupling said head suspension assembly to said slider, further comprising the step:
coupling said slider to said flexure finger.

15. The method of claim 14, wherein the step coupling said slider to said flexure finger, further comprises the step: coupling said slider to a micro-actuator assembly mounted on said flexure finger.

16. The head gimbal assembly as a product of process of claim 14.

17. A method of manufacturing said head suspension assembly of claim 5, comprising the step: coupling said flexure finger to said load beam to create said head suspension assembly.

18. The head suspension assembly as a product of the process of claim 17.

19. A method of manufacturing said flexure finger, comprising the step: making said at least two tail stress relief gaps in said stainless steel layer in the tail transition region near said head suspension assembly to create said flexure finger.

20. The flexure finger as a product of the process of claim 19.
